(19) United States
(12) Patent Application Publication
(10) Pub. No.: US 2010/0235883 A1
(43) Pub. Date: Sep. 16, 2010

(54) INFORMATION PROCESSING APPARATUS, METHOD OF CONTROLLING THE SAME, AND STORAGE MEDIUM

(75) Inventor: Eiichi Sato, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/724,703

(22) Filed: Mar. 16, 2010

(30) Foreign Application Priority Data
Mar. 16, 2009 (JP) 2009-063020

(51) Int. Cl. G06F 3/01; G06F 21/00

(52) U.S. Cl. 726/3; 715/740

(57) ABSTRACT

A mechanism for ensuring security even when there is a possibility that an information processing apparatus capable of being operated from an external device via a network is connected to a global network. An information processing apparatus has a NIC section for connection a network, and can be remotely operated from an external device connected to the network. A CPU determines whether the network to which the NIC section is connected is a local network. If it is determined that the network to which the NIC is connected is not a local network, the CPU restrict remote operation from the external device.

### BACKGROUND OF THE INVENTION

1. Field of the Invention

The present invention relates to an information processing apparatus capable of being remotely operated from an external device connected thereto via a network, and a method of controlling the same.

2. Description of the Related Art

Conventionally, it has been known that an information processing apparatus (image forming apparatus, for example) is communicably connected to an external device via a network such that the information processing apparatus is remotely operated by the external device.

According to a technique disclosed e.g. in Japanese Patent Laid-Open Publication No. 2002-007095, an image forming apparatus is equipped with a Web server function, and in response to a request from an external device connected thereto via a network, the image forming apparatus transmits screen information described using HTML (Hypertext Markup Language) to the external device. The external device uses a Web browser function to display an operation screen based on the received screen information, and transmits an instruction from the user via the operation screen.

Particularly, the technique disclosed in Japanese Patent Laid-Open Publication No. 2002-007095 makes it possible for the user at a location remote from the image forming apparatus to view information on a job being executed by the image forming apparatus, by transmitting screen information for displaying the information on the job to the external device. Further, the user can issue an instruction for execution, deletion, etc. of a job from the external device. That is, the user is capable of remotely operating the image forming apparatus.

Although it is known as described above to remotely operate an information processing apparatus connected to a network from an external device on the network, there sometimes arise problems depending a network to which the information processing apparatus is connected.

That is, the form of network connection of an information processing apparatus is broadly classified into a general form in which the image forming apparatus 1805 is connected a local network 1804 (local area network (LAN)) and then connected to a global network 1802 via a firewall 1803, as shown in FIG. 18, and a special form in which the image forming apparatus 1805 is directly connected to the global network 1802, as shown in FIG. 19.

In general, the local network 1804 is logically disconnected from the global network 1802 by a firewall 1803, whereby the security of devices connected to the local network 1804 is ensured. On the other hand, the global network 1802 is a vast network, such as the Internet 1801, to which are connected a large number of indefinite devices, and hence each device directly connected to the global network 1802 suffers from the following problems:

When the image forming apparatus 1805 is connected to the global network 1802 (as illustrated in FIG. 19), illegal malicious users can cause the following problems:
1. Unauthorized changes in the settings of the device
2. Unauthorized manipulation of a print job stored in a print queue
3. Unauthorized printing
4. Unauthorized manipulation (view, download, deletion, etc.) of personal information (an address book, personal authentication information, etc.)
5. Virus infection
6. Use as a beachhead in a DoS attack
When a user of the image forming apparatus 1805 connects the image forming apparatus 1805 to the global network 1802 with recognition of the possibilities of occurrence of the above problems, it is possible to take risk avoidance measures, such as disabling unnecessary services and frequent changes of an administrator password. However, when the user connects the image forming apparatus 1805 to the global network 1802 without taking the risk avoidance measures, the above-described problems can be caused.

### SUMMARY OF THE INVENTION

The present invention provides a mechanism for ensuring security even when there is a possibility that an information processing apparatus capable of being operated from an external device via a network is connected to a global network.

In a first aspect of the present invention, an information processing apparatus that has an interface unit connectable to a network and is capable of being operated from an external device via the network, comprising a determination unit configured to determine whether or not the network to which the interface unit is connected is a local network, and a restriction unit configured to restrict operation from the external device when the determination unit determines that the network to which the interface unit is connected is not a local network.

In a second aspect of the present invention, there is provided a method of controlling an information processing apparatus that has an interface unit connectable to a network and is capable of being operated from an external device via the network, comprising determining whether or not the network to which the interface unit is connected is a local network, and restricting operation from the external device when it is determined by the determining that the network to which the interface unit is connected is not a local network.

In a third aspect of the present invention, there is provided a computer-readable storage medium that stores a program for causing a computer to execute a method of controlling an information processing apparatus that has an interface unit connectable to a network and is capable of being operated from an external device via the network, wherein the method comprises determining whether or not the network to which the interface unit is connected is a local network, and restricting operation from the external device when it is determined by the determining that the network to which the interface unit is connected is not a local network.

According to the present invention, it is possible to provide the mechanism for ensuring security even when there is a possibility that the information processing apparatus capable of being operated from the external device via the network is connected to the global network.

Further features of the present invention will become apparent from the following description of exemplary embodiments with reference to the attached drawings.

### BRIEF DESCRIPTION OF THE DRAWINGS

FIG. 1 is a schematic block diagram of an image forming apparatus as an information processing apparatus according to first and second embodiments of the present invention.

FIG. 2 is a block diagram of an MFC (Multi-Function Controller) appearing in FIG. 1.

FIG. 3 is a view of a setting change screen of a remote UI.

FIG. 4 is a view of a state display screen of the remote UI.

FIG. 5 is a view of a job control screen of the remote UI.

FIG. 6 is a view of an address book manipulation screen of the remote UI.

FIG. 7 is a flowchart of an outline of a process for restricting the use of a remote UI function.

FIG. 8 is a flowchart of details of the process for restricting the use of the remote UI function.

FIG. 9 is a view of a print sheet count upper limit value-setting screen of a local UI.

FIG. 10 is a flowchart of details of a remote operation restriction process on the manipulation of an address book, which is executed in a step in the FIG. 8 process for restricting the use of the remote UI function.

FIG. 11 is a view of an address book-manipulating user authentication screen of the remote UI.

FIG. 12 is a flowchart of details of a remote operation restriction process for job control, which is executed in a step in the FIG. 8 process for restricting the use of the remote UI function.

FIG. 13 is a flowchart of a security check process for checking the security of the image forming apparatus as an information processing apparatus according to the second embodiment of the present invention.

FIG. 14 is a view of a warning display screen of the local UI.

FIG. 15 is a view of a disconnection notification screen of the local UI.

FIG. 16 is a view of an information display screen of the local UI.

FIG. 17 is a view of a risk explanation screen of the local UI.

FIG. 18 is a view of a general form of network connection in which an image forming apparatus having a service provision function is connected to a local area network (LAN) and then connected to a global network via a firewall.

FIG. 19 is a view of a form of a network connection in which the image forming apparatus having the service provision function is directly connected to the global network.

### DETAILED DESCRIPTION OF THE EMBODIMENTS

The present invention will now be described in detail below with reference to the accompanying drawings showing embodiments thereof. In the following embodiments, an image forming apparatus will be described as an example of an information processing apparatus according to the present invention.

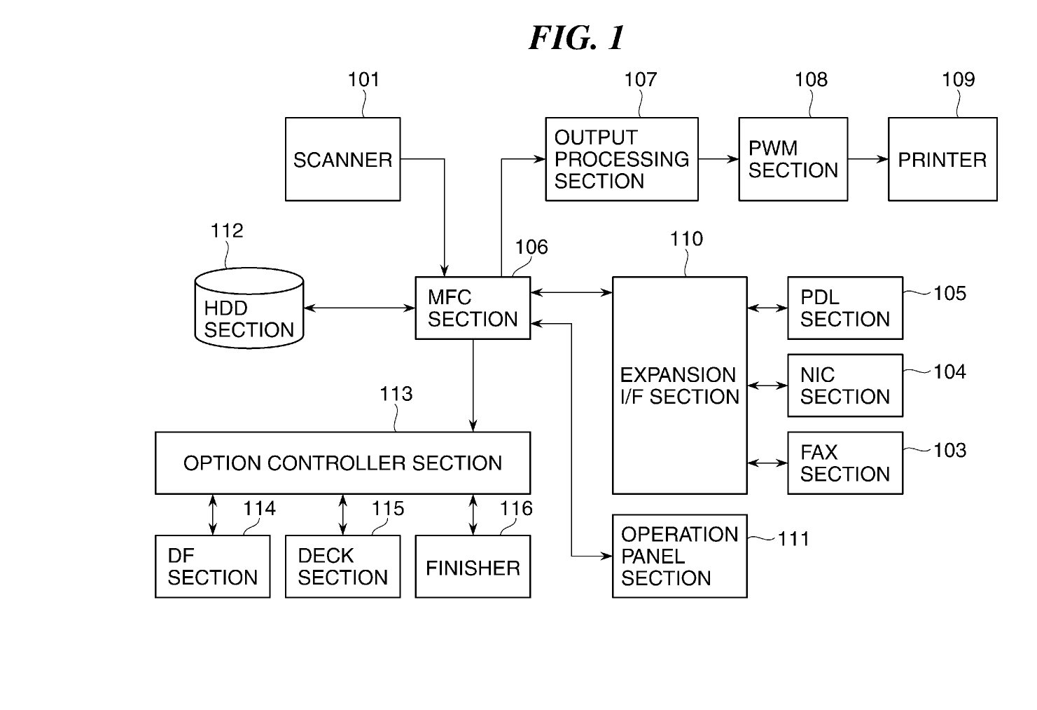

FIG. 1 is a schematic block diagram of the image forming apparatus according to first and second embodiment of the present invention. The image forming apparatus shown in FIG. 1 is connected to a client terminal via a network and has a function of being remotely operated from the client terminal, that is, a remote UI (User Interface) function.

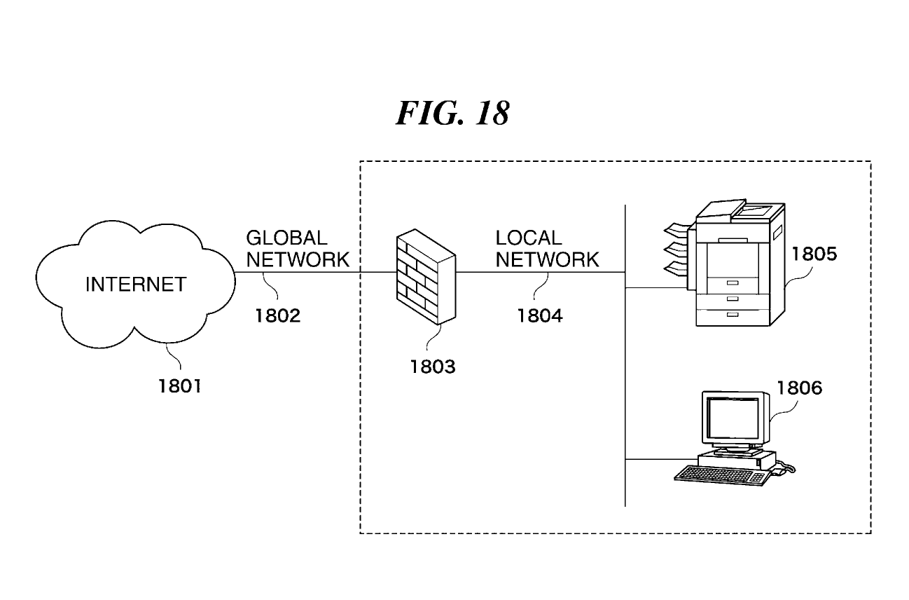

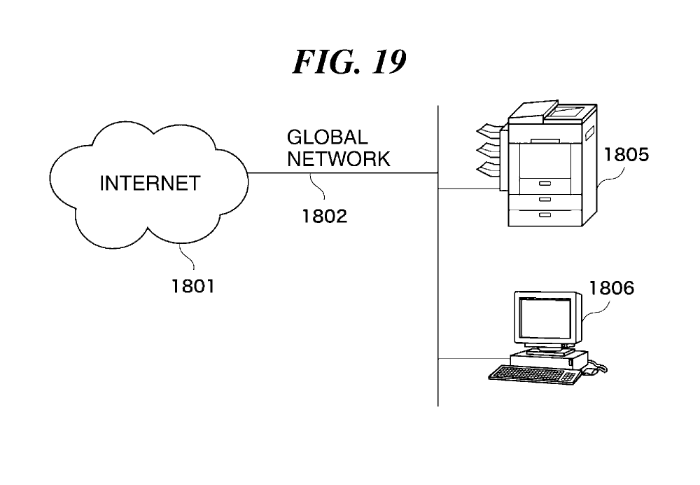

The image forming apparatus shown in FIG. 1 has one of the forms of network connection described hereinabove with reference to FIGS. 18 and 19. Therefore, in the following description, the image forming apparatus, the network and so forth will be denoted by the same reference numerals as those in FIGS. 18 and 19. However, a network-connected device 1806 illustrated in FIGS. 18 and 19 indicates not a device performing a network connection service but a device connected to the network, that is, a client terminal using the service. Therefore, in the following description, the “network-connected device” will be referred to as “the client terminal”.

In FIG. 1, a reference numeral 101 denotes a scanner for reading an image, a reference numeral 103 denotes a fax section for transmitting and receiving an image using the telephone line, and a reference numeral 104 denotes a NIC (Network Interface Card) section for connecting the image forming apparatus 1805 to the network, such as a LAN (Local Area Network). A reference numeral 105 denotes a PDL (Page Description Language) section for converting PDL data transmitted from the client terminal 1806 or the like into image signals, and a reference numeral 110 denotes an expansion interface (I/F) section for connecting expansion blocks, such as the PDL section 105, the NIC section 104 and the fax section 103, to the image forming apparatus.

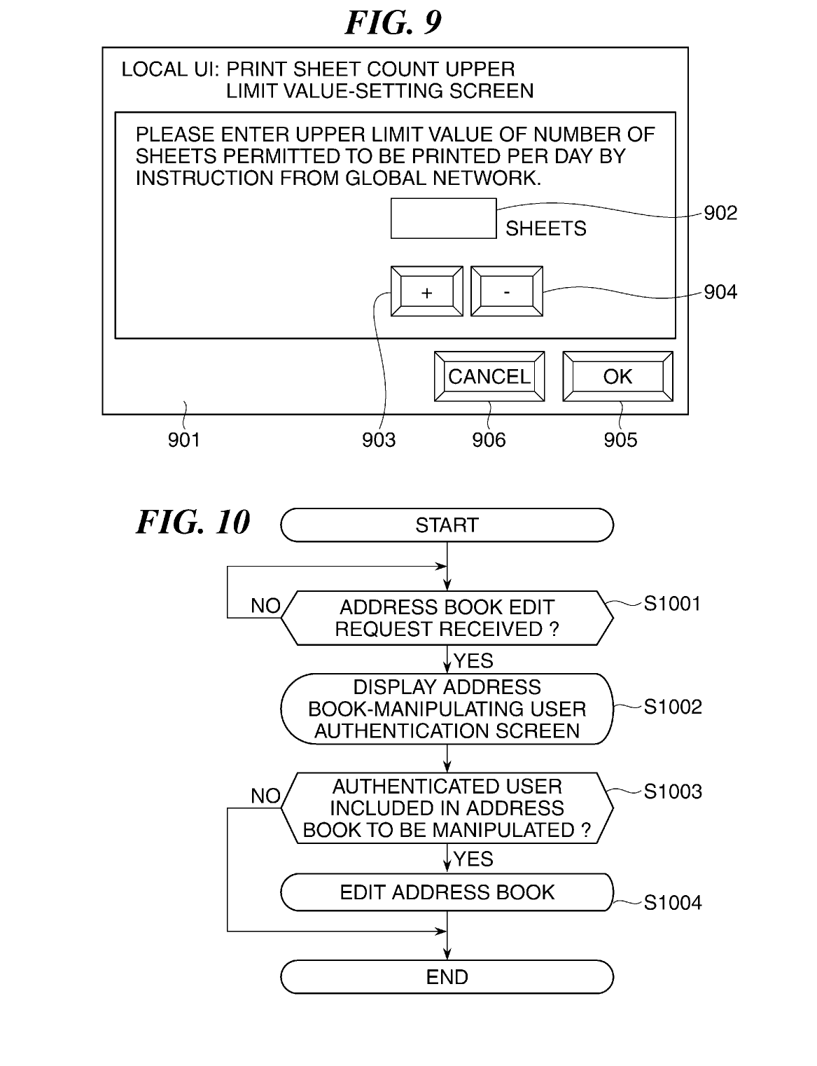

A reference numeral 111 denotes an operation panel section comprised of an LCD (Liquid Crystal Display) and a switch group. The LCD of the operation panel section 111 displays UI (User Interface) screens, described hereinafter with reference to FIG. 9 and FIGS. 14 to 17.

A reference numeral 112 denotes a HDD (Hard Disk Drive) section used e.g. for a temporary image data storage area and a cache area of a program being executed, and a reference numeral 113 denotes an option controller section for providing interface between the image forming apparatus 1805 and optional devices. A reference numeral 107 denotes an output processing section for performing image processing on print data, a reference numeral 108 denotes a PWM (Pulse Width Modulation) section for generating a signal for modulating a laser beam based on image data, and a reference numeral 109 denotes a printer for printing on sheets. A reference numeral 106 denotes an MFC (Multi-Function Controller) section for controlling the devices of the image forming apparatus 1805 and a flow of image data.

Further, reference numerals 114, 115 and 116 denote the optional devices connected to the image forming apparatus 1805. The reference numeral 114 denotes a DF (Document Feeder) section for continuously feeding documents to the scanner 101. The reference numeral 115 denotes a deck section for stacking and feeding a large number of recording sheets at the same time, and a reference numeral 116 denotes a finisher for performing finishing processing on recording sheets printed out.

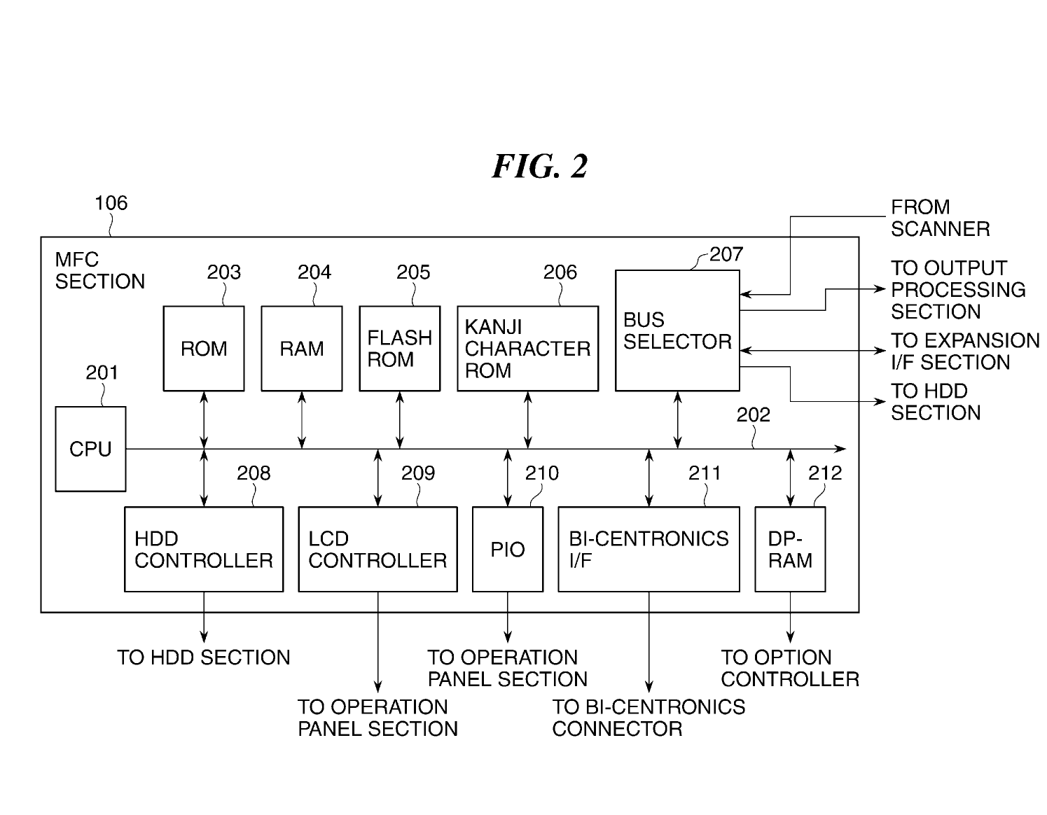

FIG. 2 is a block diagram of the MFC section 106 shown in FIG. 1. A bus selector 207 of the MFC section 106 manages routes for transferring image signals (image data) by selectively switching a bus. More specifically, the bus selector 207 selectively switches the bus to thereby control the transfer routes used for transferring image data for executing various functions of the image forming apparatus 1805, including e.g. a copy function, a network scanning function, a network printing function, and FAX transmission and reception functions.

As the transfer routes for transferring image data, there can be considered the following routes:
Copying machine: Scanner 101→Bus selector 207→Printer 109
Network scanning function: Scanner 101→Bus selector 207→NIC section 104
Network printing function: NIC section 104→Bus selector 207→Printer 109
FAX transmission function: Scanner 101→Bus selector 207→Fax section 103
FAX reception function: Fax section 103→Bus selector 207→Printer 109
Further, image data having passed through the bus selector 207 is transmitted to the HDD section 112, and is stored in a HDD (Hard Disk Drive), as required. In this case, the image data can also be stored in the HDD section 112 as data compressed by a compression section (not shown) integrated in the HDD section 112. Image data can be compressed by using any of general compression methods, such as JPEG, JBIG, ZIP, LZH, MH, MR or MMR. Compressed image data are managed on a job-by-job basis, and are stored in the HDD section 112 as files each with additional data of a file name, a creators, a date and time of file creation, and a file size.

The MFC section 106 not only controls the above-mentioned image data transfer routes but also provides overall control of various processes performed by the image forming apparatus 1805. When each of these processes is to be performed, a CPU (Central Processing Unit) 201 reads a program and data step by step from a ROM (Read Only Memory) 203 and a flash ROM 205 via a CPU bus 202. A RAM (Random Access Memory) 204 is used as a work area for temporarily storing data during execution of the programs. A kanji character ROM 206 converts character codes into kanji character pattern data. This makes it possible to display kanji characters on the LCD of the operation panel section 111.

A HDD controller 208 controls reading/writing of data in/from the HDD section 112 under the control of the CPU 201. An LCD controller 209 controls the display of messages and images on the LCD of the operation panel section 111, the transmission of operation signals from a touch panel integrally formed with the LCD to the CPU 201, and so forth. A PIO (Parallel Input/Output) 210 is connected a group of key switches of the operation panel section 111, and transmits an operation signal from a key switch to the CPU 201.

A bi-Centronics interface (I/F) 211 can perform interactive communication with an external computer connected to the image forming apparatus 1805 via a bi-Centronics connector (not shown) to thereby take programs and data into the image forming apparatus 1805. The taken-in programs or data are read in the flash ROM 205 under the control of the CPU 201. Such a data transfer process makes it possible to upgrade the version of a control program and correct bugs of the control program without hardware replacement of the ROM. A DP(Dual Port)-RAM 212 is used for communication with the option controller section 113, and is accessible from both the CPU 201 and the option controller section 113.

The image forming apparatus 1805 is provided with the remote UI function, as described above, so as to be remotely operated from the client terminal 1806 connected to the network.

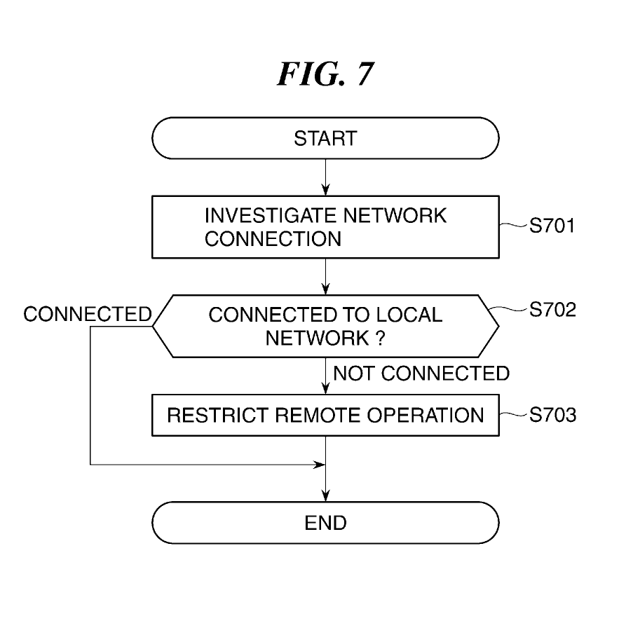

An HTTP server application (program) required for realizing a remote UI is stored in the HDD section 112, and when the image forming apparatus 1805 is started, it is loaded into the RAM 204 by the CPU 201 of the MFC section 106, for execution. The above-mentioned HTTP server application includes a program for processes described hereinafter with reference to FIGS. 7, 8, 10, 12 and 13.

Further, a control program for realizing the remote UI function as an HTTP server (Web server) is also stored in the HDD section 112. This control program is read out by the HTTP server application on the RAM 204 at the start of the HTTP server, and is executed.

The HTTP server application executed by the MFC section 106 has the function of making the URL of the remote UI thereof open to the public via the expansion interface section 110, the NIC section 104, a local network 1804 and a global network 1802. Therefore, the client terminal 1806 is capable of remotely operating the image forming apparatus 1805 by starting a Web browser contained therein and designating the URL of the remote UI made open to the public.

In the present embodiment, when the image forming apparatus 1805 is directly connected to the global network 1802, the remote operation of the image forming apparatus 1805 using the remote UI function is restricted. This restriction will be described in detail hereinafter.

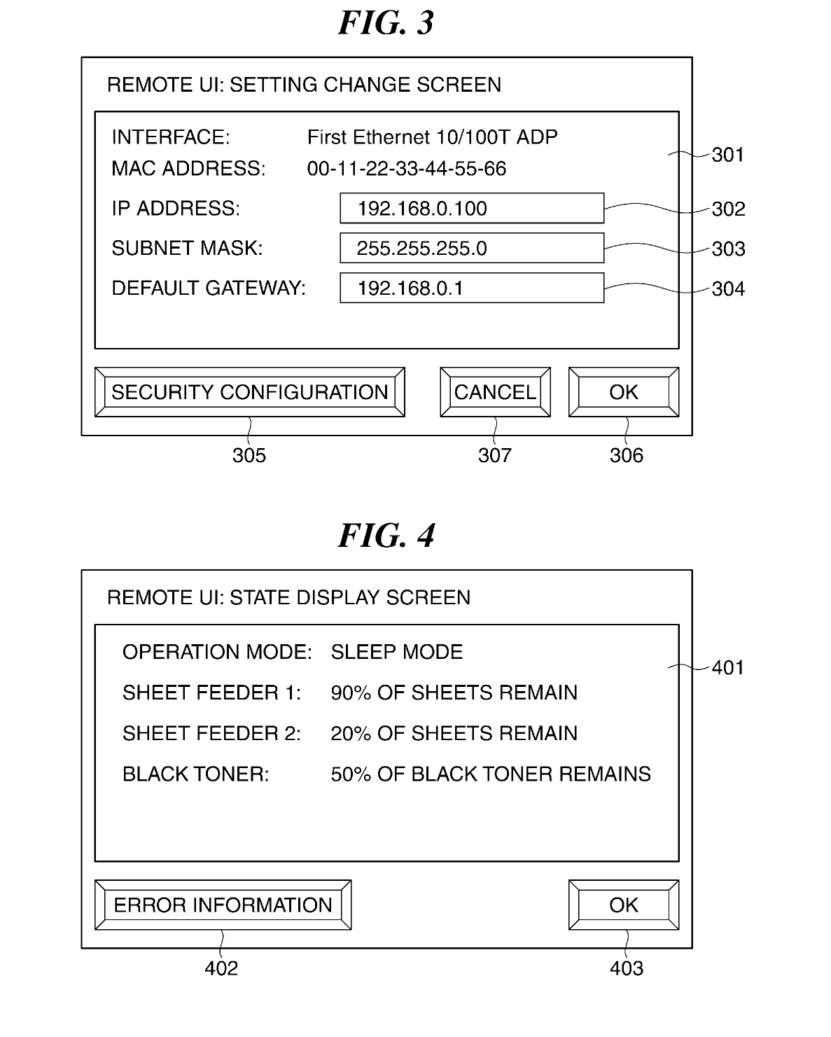

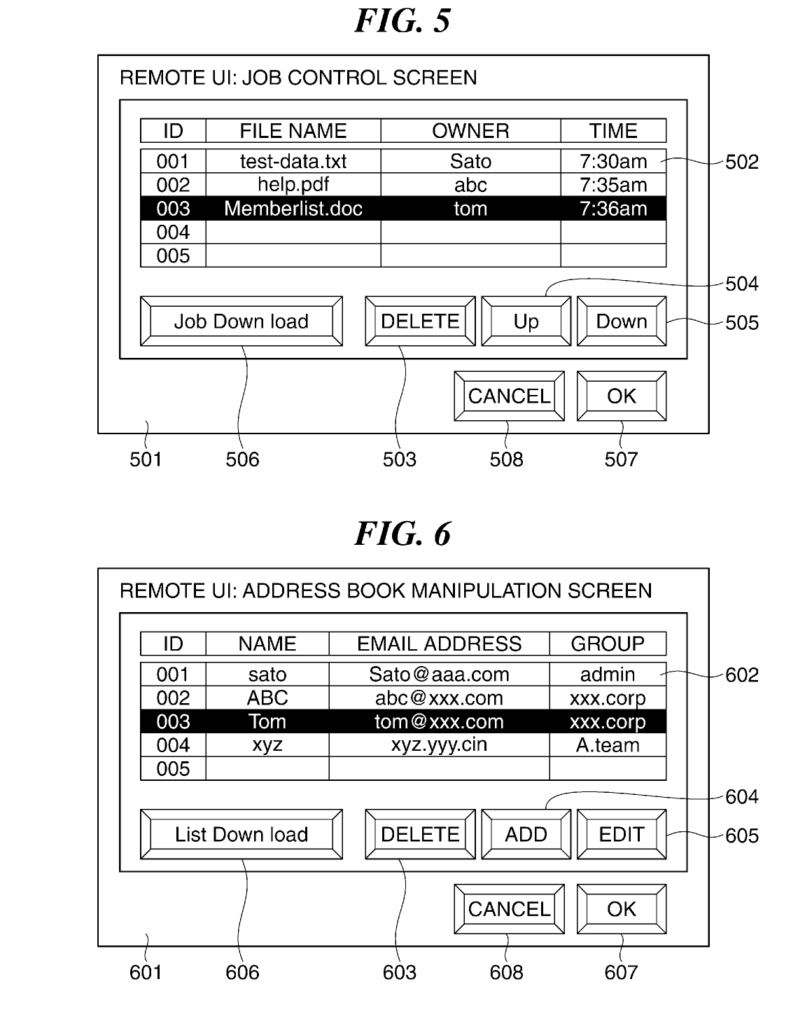

By the remote UI function, the image forming apparatus 1805 permits the client terminal 1806 to perform the following types of the remote operation:
1. Change the settings of the image forming apparatus 1805 (see FIG. 3)
2. Display the state of the image forming apparatus 1805 (see FIG. 4)
3. Control a print job (deletion, change in a printing order, and download of a job stored in the image forming apparatus 1805: see FIG. 5)
4. Manipulate an address book (addition, deletion and edition of an address, and download of an address list: see FIG. 6)

FIG. 3 shows a setting change screen (UI screen) of the remote UI. The setting change screen 301 illustrated in FIG. 3 displays information inhibited from being changed, such as a MAC address of the image forming apparatus 1805, and includes three input boxes for changing the settings of the image forming apparatus 1805. A reference numeral 302 denotes an entry box for entering the IP address of the image forming apparatus 1805, a reference numeral 303 denotes an entry box for entering a subnet mask, and a reference numeral 304 denotes an entry box for entering an address of a default gateway.

A reference numeral 305 denotes a security configuration button for displaying a UI screen for configuring settings of a security function, such as an IP address filter or a MAC address filter. A reference numeral 306 denotes an OK button for finally determining settings input to the above-described input boxes 302 to 304, and a reference numeral 307 denotes a cancel button for canceling the configuration. The setting change screen may be configured such that security settings other than the above-mentioned ones can be changed.

The UI screen of the remote UI, that is, a screen having a character string “REMOTE UI” displayed at an upper left corner thereof is made available to the client terminal 1806, and is displayed on a display section (not shown) of the client terminal 1806 using a Web browser function of the client terminal 1806. Further, a UI screen of a local UI, that is, a screen having a character string “LOCAL UI” displayed at an upper left corner thereof is displayed on the LCD of the operation panel section 111 of the image forming apparatus 1805.

FIG. 4 shows a state display screen (UI screen) of the remote UI. The state display screen 401 illustrated in FIG. 4 displays various kinds of information concerning the state of the image forming apparatus 1805, such as an operation mode of the image forming apparatus 1805, the number of sheets remaining in a sheet feeder and the amount of remaining toner. A reference numeral 402 denotes an error information button for displaying information on an error generated in the image forming apparatus 1805, and a reference numeral 403 denotes an OK button for closing the state display screen 401.

FIG. 5 shows a job control screen (UI screen) of the remote UI. The job control screen 501 illustrated in FIG. 5 shows a job list 502 of print jobs stored in a print queue. This list shows job IDs, file names, the names of owners of jobs, time information as to when the jobs are received, and so forth. When one of the displayed job IDs is clicked by operating a mouse, the information items associated with a job having the ID assigned thereto are displayed in reverse video.

A reference numeral 503 denotes a delete button for deleting a selected job from the print queue, a reference numeral 504 denotes an Up button for moving the selected job to a higher row, which represents a higher printing order, of the print queue, and a reference numeral 505 denotes a Down button for moving a selected job to a lower row, which represents a lower printing order, of the print queue. A reference numeral 506 denotes a Job Download button for downloading a selected job to the client terminal 1806.

Although the present embodiment is configured such that print jobs stored in the print queue can be downloaded, jobs stored in a printed queue or the HDD section 112 may be configured to be permitted to be downloaded. A reference numeral 507 denotes an OK button for causing an operation performed using the job control screen 501 to be reflected on the image forming apparatus 1805, and a reference numeral 508 denotes a cancel button for canceling an operation performed using the job control screen 501.

FIG. 6 is a view of an address book manipulation screen (UI screen) of the remote UI. The address book manipulation screen 601 illustrated in FIG. 6 displays addresses in the address book stored in the HDD section 112 as a list. Items of display of the address book include an address book ID, a personal name, an email address and a group name. When a displayed address book ID is clicked by operating the mouse, the items of address book information associated with the address book ID are displayed in reverse video.

A reference numeral 603 denotes a delete button for deleting selected address information, a reference numeral 604 denotes an add button for adding address information to the address book, and a reference numeral 605 denotes an edit button for displaying an edit screen for use in editing selected address information. A reference numeral 606 denotes a List Download button for downloading the list of address information in the address book to the client terminal 1806, and a reference numeral 607 denotes an OK button for causing an operation performed using the address book manipulation screen 601 to be reflected on the image forming apparatus 1805. A reference numeral 608 denotes a cancel button for canceling an operation performed using the address book manipulation screen 601.

Next, an outline of a process for restricting the use of the remote UI function, i.e. for restricting the remote operation using the remote UI function will be described with reference to FIG. 7.

When the image forming apparatus 1805 is started, the CPU 201 investigates a form of network connection of the image forming apparatus 1805 (S701). Next, the CPU 201 determines based on the result of the investigation whether or not the image forming apparatus 1805 is directly connected to the local network 1804 (S702). In other words, in the step S702, the CPU 201 determines whether or not the network to which the NIC section 104 is connected is a local network.

If the image forming apparatus 1805 is directly connected to the local network 1804, the CPU 201 terminates the present process without restricting the remote operation using the remote UI function.

Therefore, if the image forming apparatus 1805 is directly connected to the local network 1804, the client terminal 1806 can use all the services provided as the remote UI function by the image forming apparatus 1805.

On the other hand, if the image forming apparatus 1805 is not directly connected to the local network 1804 (if it is impossible to finally determine that the image forming apparatus 1805 is directly connected to the local network 1804), the CPU 201 restricts the remote operation using the remote UI function (S703). That is, the remote operation of the image forming apparatus 1805 which is not directly connected to the local network 1804, using the remote UI function, is restricted, and hence the client terminal 1806 can use only part of the services provided by the image forming apparatus 1805.

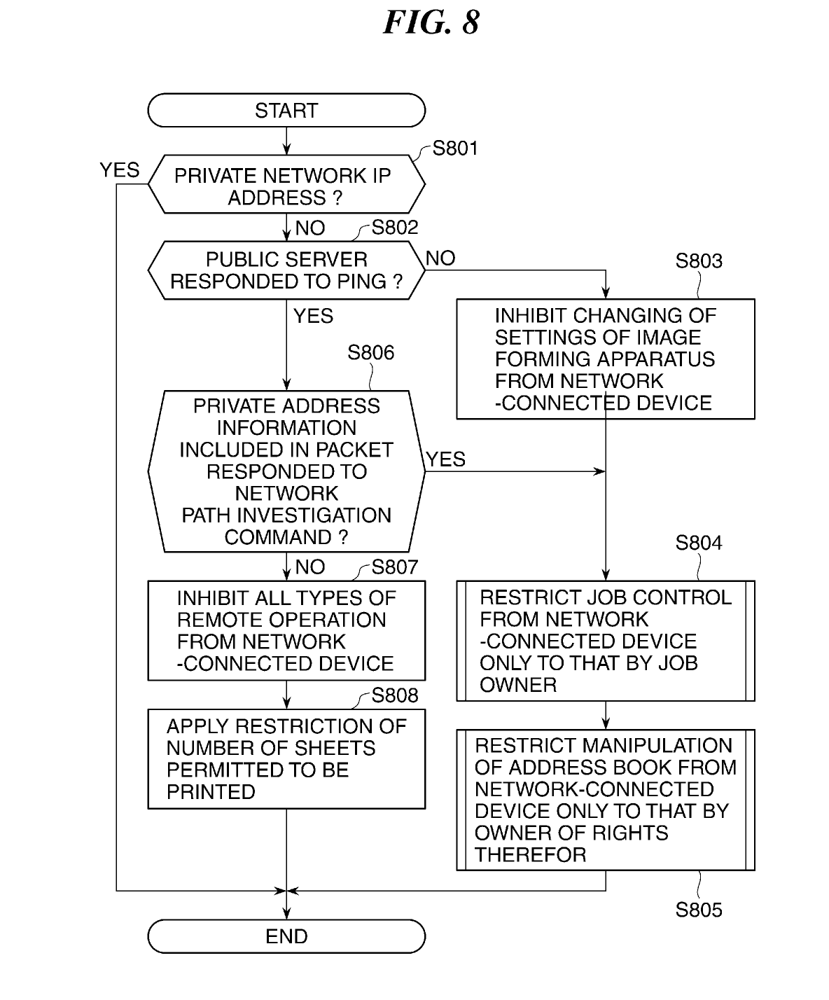

Next, details of the process for restricting the use of the remote UI function, i.e. for restricting the remote operation using the remote UI function will be described with reference to FIG. 8.

When the image forming apparatus 1805 is started, the CPU 201 thereof determines whether or not an IP address currently set as the IP address of the image forming apparatus 1805 is a private network address (S801). In this determination process, the image forming apparatus 1805 singly performs the determination without cooperating with the client terminal 1806 as follows:

Address spaces of IP addresses to be used by private networks, such as internal company LANs, are reserved as follows:
Class A: 10.0.0.0 to 10.255.255.255
Class B: 172.16.0.0 to 172.31.255.255
Class C: 192.168.0.0 to 192.168.255.255
Therefore, if the current IP address of the image forming apparatus 1805 belongs to any of the above-mentioned address spaces, it is possible to definitely determine that the image forming apparatus 1805 is directly connected to the local network 1804, not to the global network 1802.

If the current IP address of the image forming apparatus 1805 is a private IP address, the CPU 201 terminates the present process without restricting the remote operation using the remote UI function.

On the other hand, if the currently set IP address of the image forming apparatus 1805 is a global IP address, the CPU 201 transmits (delivers) a ping (predetermined signal) to a public server on the global network (Internet 1801). Then, the CPU 201 determines whether or not a response signal to the ping is received (S802). This determination process is performed for further security since even a device within the local network 1804 is sometimes operated using a global IP address.

Examples of the public server include a DNS (Domain Name System) server, an NTP (Network Time Protocol) server, and so forth. Further, the term “ping” is intended to mean an operation for transmitting (delivering) an echo request of an ICMP (Internet Control Message Protocol) to a specific IP address and receiving an echo reply (response signal) sent back from the IP address.

When it is impossible to receive the echo reply from the public server on the Internet by ping, it is possible to estimate that the degree of possibility of the image forming apparatus 1805 being directly connected to the global network 1802 is moderate. However, it is not considered to be safe to judge that the image forming apparatus 1805 is connected to the local network 1804 since the global IP address is used for the image forming apparatus 1805, for example.

Therefore, if the echo reply cannot be received from the public server on the Internet, the CPU 201 inhibits a change in the setting information of the image forming apparatus 1805 by remote operation from the client terminal 1806 (S803).

Next, the CPU 201 restricts job control by remote operation from the client terminal 1806, i.e. job control from the FIG. 5 job control screen 501 to job control by a job owner (S804). Further, the CPU 201 restricts the manipulation of the address book by the remote operation from the client terminal 1806, i.e. the manipulation of the address book from the FIG. 6 address book manipulation screen 601 to manipulation performed only by the owner of rights for manipulating the address book (S805). Details of the processes performed in the steps S804 and S805 will be described hereinafter with reference to FIGS. 12 and 10, respectively.

When the echo reply to the ping transmission is received from the public server on the Internet, the CPU 201 investigates a network path (communication path) to the public server which has sent back the echo reply (S806). It is possible to perform the investigation of the network path using a network path investigation command (traceroute or the like).

The investigation of the network path is performed since the echo reply from the public server can be received insofar as the transmission and reception of an ICMP packet are not blocked by a firewall 1803, even when the image forming apparatus 1805 is connected to the local network 1804.

The CPU 201 can acquire the IP address information of hosts (relay devices) having relayed the packet via a path extending from the image forming apparatus 1805 to the public server, using the above-mentioned network path investigation command. Therefore, in the step S806, the CPU 201 searches the acquired IP address information of the relay hosts (relay devices) for any of the above-mentioned private network address, to thereby investigate whether or not there is any relay host having a private network address.

In this case, if there is any relay host having a private network address, the CPU 201 can estimate that the degree of possibility of the image forming apparatus 1805 being directly connected to the global network 1802 is small. However, it is not considered to be safe to determine that the image forming apparatus 1805 is directly connected to the local network 1804 since the global IP address is used for the image forming apparatus 1805, for example.

Therefore, if there is a relay host having a private network address, the CPU 201 restricts part of the remote operation of the image forming apparatus 1805 from the client terminal 1806. More specifically, the CPU 201 restricts the job control by remote operation from the client terminal 1806 to job control by the owner of a job to be executed (S804). Further, the CPU 201 restricts the manipulation of the address book by remote operation from the client terminal 1806, i.e. the remote manipulation of the address information stored in the information processing apparatus to operation performed only by the owner of rights for manipulating the address book (address information) (S805).

On the other hand, if there is no relay host having a private network address, the CPU 201 can estimate that the degree of possibility of the image forming apparatus 1805 being directly connected to the global network 1802 is large.

Therefore, if there is no relay host having a private network address, the CPU 201 totally inhibits the remote operation of the image forming apparatus 1805 from the client terminal 1806 (S807). This total inhibition makes it impossible for the client terminal 1806 to remotely operate the image forming apparatus 1805 using the remote UI function, but the image forming apparatus 1805 can only be operated by local UI function using the operation panel section 111.

Further, the CPU 201 restricts the number of sheets which can be designated for printing by remote operation from the client terminal 1806 (S808). More specifically, the CPU 201 applies an upper limit value of the number of sheets permitted to be printed per a predetermined time period to the remote operation from the client terminal 1806. In the present embodiment, the upper limit value of the number of sheets permitted to be printed is set in advance by operating the operation panel section 111 of the image forming apparatus 1805 via a print sheet count upper limit value-setting screen 901 of the local UI function, shown in FIG. 9, and is stored in the flash ROM 205 of the image forming apparatus 1805.

When the image forming apparatus 1805 is configured such that the above-mentioned restriction of the number of sheets for printing is applied to an operator of the image forming apparatus 1805 on an as-needed basis, it is also possible to inhibit the operator from changing, by remote operation from the client terminal 1806 via the UI screen based on the remote UI function, the setting of the upper limit value of the number of sheets permitted to be printed.

As described hereinabove, in the first embodiment, when there is a possibility that the image forming apparatus 1805 is directly connected to the global network 1802, the remote operation of the image forming apparatus 1805 is stepwise restricted according to the degree of the possibility.

The manner of stepwise restriction of the remote operations is by no means limited to that described above with reference to FIG. 8. For example, when it is estimated that the degree of possibility of the image forming apparatus 1805 being directly connected to the global network 1802 is moderate, only the changing of the setting of the image forming apparatus 1805 may be inhibited but the restriction may be inhibited from being executed according to the rights to perform the job control and manipulate the address book. Further, when the degree of the possibility is moderate, it is also possible to inhibit the settings of the image forming apparatus from being changed and at the same apply the upper limit value of the number of sheets permitted to be printed to the remote operation from the client terminal.

Next, a detailed description will be given of the process for stepwise restriction of the remote operation according to the degree of the possibility of the image forming apparatus 1805 being directly connected to the global network 1802.

The print sheet count upper limit value-setting screen 901 of the local UI shown in FIG. 9 is provided with an entry box 902 for entering the upper limit value of the number of sheets permitted to be printed per day by remote operation from the client terminal 1806. A reference numeral 903 denotes a plus button for incrementing the number of sheets permitted to be printed, and a reference numeral 904 denotes a minus button for decrementing the number of sheets permitted to be printed.

A reference numeral 905 denotes an OK button for finally determining the upper limit value of the number of sheets permitted to be printed, which is entered in the entry box 902. Upon detection of the pressing of the OK button 905, the CPU 201 stores the upper limit value of the number of sheets permitted to be printed, which is set on the print sheet count upper limit value-setting screen 901 in the flash ROM 205. A reference numeral 906 denotes a cancel button for canceling the upper limit value of the number of sheets permitted to be printed, which is entered in the entry box 902.

The CPU 201 controls the image forming apparatus 1805 such that sheets exceeding in number than the number of sheets permitted to be printed, which is stored in the flash ROM 205, cannot be printed per day. This makes it possible to prevent such printing as will consume a large number of recording sheets from being executed by malicious intension.

FIG. 10 is a flowchart of details of the process executed in the step S805 in the FIG. 8 process for restricting the use of the remote UI function, that is, a remote operation restriction process on the manipulation of the address book.

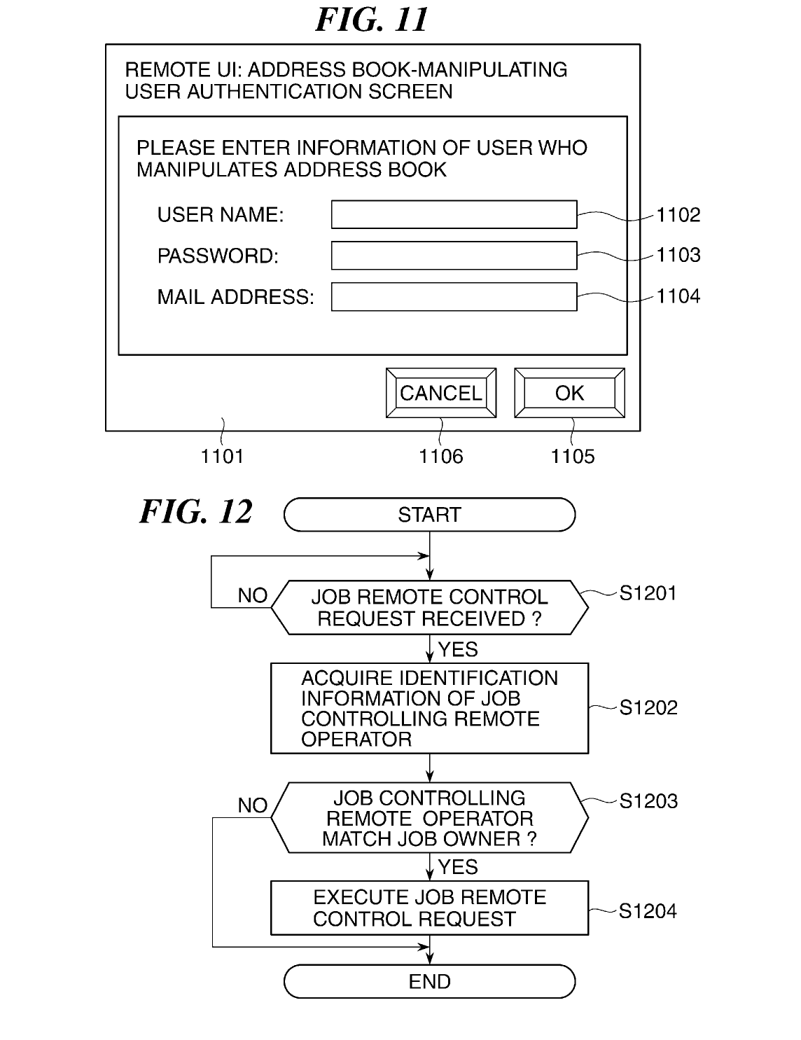

When the CPU 201 determines that the degree of possibility of the image forming apparatus 1805 being directly connected to the global network 1802 is moderate or less, the CPU 201 awaits an address book edit request from the client terminal 1806 (S1001). In this case, upon receipt of a signal indicating that the OK button 607 or the List Download button 606 on the FIG. 6 address book manipulation screen 601 has been pressed, the CPU 201 recognizes that the address book edit request has been received. When the address book edit request has been received from the client terminal 1806, the CPU 201 transmits an address book-manipulating user authentication screen 1101 illustrated in FIG. 11 to the client terminal 1806 as a requesting device, for causing the client terminal 1806 to display the screen 1101 (S1002).

The address book-manipulating user authentication screen 1101 illustrated in FIG. 11 is a UI screen for authenticating an operator of the address book. The address book-manipulating user authentication screen 1101 shown in FIG. 11 includes a user name entry box 1102, a password entry box 1103 and a mail address entry box 1104, as an authentication information input section. Further, the address book-manipulating user authentication screen 1101 includes an OK button 1105 for finally determining authentication information entered in the above-mentioned boxes 1102 to 1104, and a cancel button 1106 for canceling the entered authentication information.

The CPU 201 determines whether or not the authentication information input to the address book-manipulating user authentication screen 1101 is correct and the operator (user) associated with the authentication information has an entry in the address book (S1003). If the user associated with the authentication information has an entry in the address book, the CPU 201 edits the address book according to the instruction from the client terminal 1806 as the requesting device (S1004).

On the other hand, if the user associated with the authentication information has no entry in the address book, the CPU 201 terminates the present process without editing the address book. This permits manipulation of only an address book having an entry of the address information of the user himself by remote operation using the remote UI function. In other words, it is possible to prevent an unauthorized manipulation of the address book by a third party.

FIG. 12 is a flowchart of details of the process executed in the step S804 in the FIG. 8 process for restricting the use of the remote UI function, that is, a remote operation restriction process for job control.

When the CPU 201 determines that the degree of possibility of the image forming apparatus 1805 being directly connected to the global network 1802 is moderate or less, the CPU 201 awaits a job remote control request from the client terminal 1806 (S1201). In this case, upon receipt of a signal indicating that the OK button 507 or the Job Download button 506 on the FIG. 5 job control screen 501 has been pressed, the CPU 201 recognizes that the job remote control request has been received.

Next, the CPU 201 acquires information for identifying a remote operator who has transmitted the job remote control request (S1202). In the present embodiment, the CPU 201 acquires the source IP address of the client terminal 1806, and uses the same as the remote operator identification information.

The CPU 201 determines whether or not the acquired source IP address of the remote operator and the source IP address of the client terminal 1806 that has transmitted a print job associated with the job remote control request match each other (S1203). More specifically, the CPU 201 determines whether or not the job remote control request is made by a job owner who owns the print job. Now, the source IP address of the client terminal 1806 having transmitted the print job is stored in the RAM 204 together with information (including the information stored in the printed queue) displayed in the job list 502 shown in FIG. 5.

If the job remote control request is made by a job owner who owns the print job, the CPU 201 executes the print job associated with the job remote control request (S1204). On the other hand, if the job remote control request is made by a job owner who does not own the print job, the CPU 201 ignores the job remote control request, and terminates the process associated with the remote control request. From the above, it is possible to prevent unauthorized control of a print job by a third party.

Although in the above-described embodiment, to identify a remote operator, the source IP address of the client terminal 1806 is acquired and used as the identification information of the remote operator, it is also possible to identify the remote operator by performing personal authentication in advance and compare the authenticated remote operator with the name of a job owner of a print job associated with a remote control request.

In the first embodiment, when there is a possibility that the image forming apparatus 1805 is directly connected to the global network 1802, the degree of restriction to the remote operation of the image forming apparatus 1805 is changed according to the degree of the possibility.

On the other hand, in a second embodiment, when there is a possibility that the image forming apparatus 1805 is connected to the global network 1802, the security of the image forming apparatus 1805 which is remotely operated is determined, and according to the degree of the security, a countermeasure is taken, including disconnection of communication and giving of a warning.

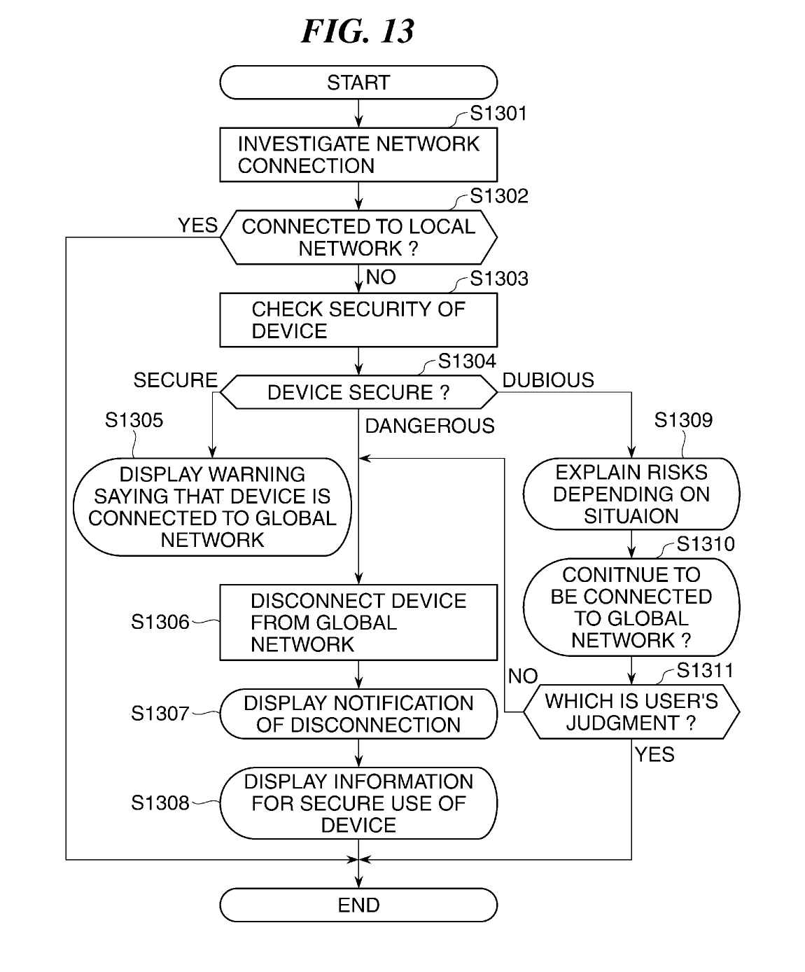

Hereinafter, a security check process for checking the security of the image forming apparatus 1805 according to the second embodiment will be described with reference to FIG. 13.

When the image forming apparatus 1805 is started, the CPU 201 investigates a form of network connection of the image forming apparatus 1805 (S1301). Similarly to the first embodiment, the image forming apparatus 1805 can singly perform this investigation based on the address space of the IP address thereof without cooperating with the client terminal 1806.

Next, based on the result of the investigation, the CPU 201 determines whether or not the image forming apparatus 1805 is directly connected to the local network 1804 (S1302). If it can be positively determined that the image forming apparatus 1805 is directly connected to the local network 1804, the CPU 201 terminates the present process since it is possible to use the remote UI function in a secure manner. In the case of this form of network connection, a message saying that the remote UI function can be used in a secure manner may be displayed on the client terminal 1806.

Therefore, if it is certain that the image forming apparatus 1805 is directly connected to the local network 1804, the client terminal 1806 can utilize all the services that the image forming apparatus 1805 provides by the remote UI function.

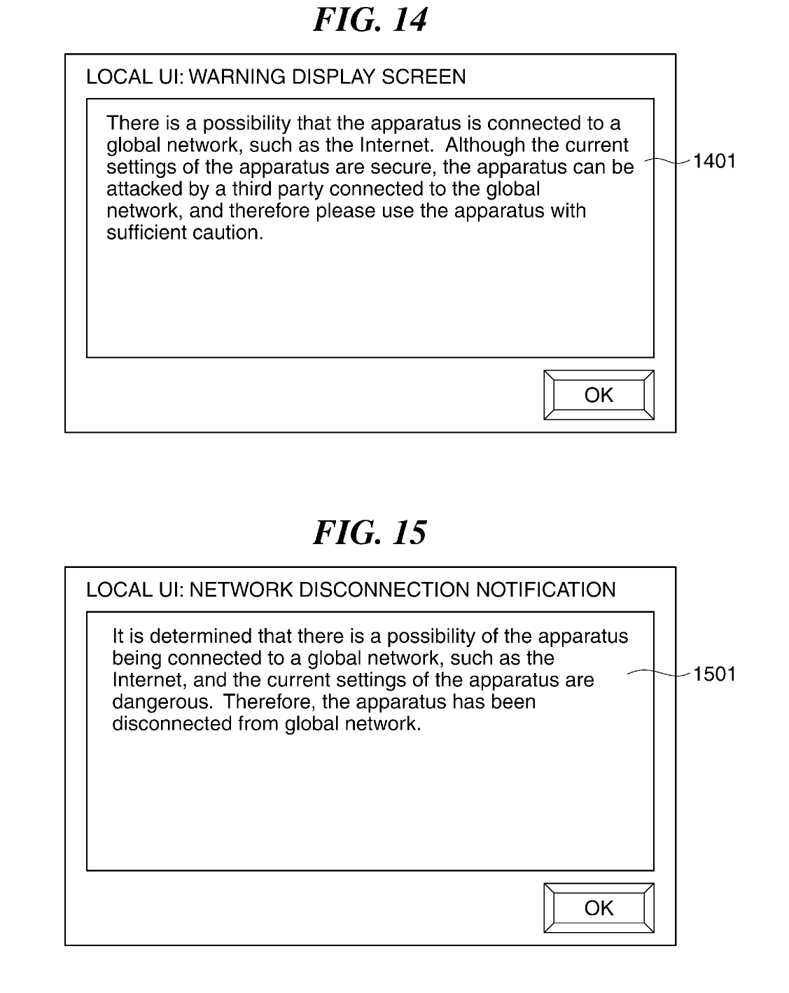

On the other hand, if it is not certain that the image forming apparatus 1805 is directly connected to the local network 1804, the CPU 201 checks the security of each current setting of the image forming apparatus 1805 (S1303), and determines if the current settings of the image forming apparatus 1805 are secure (S1304). This process for determining the security of the settings is performed by checking the following points:
1. Whether the password of an administrator of the remote UI is changed from an initial value.
2. Whether the currently set administrator password is highly secure.
3. Whether a service having a known vulnerability remains active?
If the settings of the image forming apparatus 1805 are secure, the CPU 201 displays a warning saying that there is a possibility of the image forming apparatus 1805 being directly connected to a dangerous global network, but the settings of the image forming apparatus 1805 are secure (have a high degree of security), on the LCD of the operation panel section 111 (S1305). FIG. 14 shows an example of a warning display screen 1401 in this case.

The above warning display enables the operator of the image forming apparatus 1805 to recognize that there is a possibility of the image forming apparatus 1805 being directly connected to the global network 1802 and the image forming apparatus 1805 is exposed to a certain threat. After the warning is displayed, the CPU 201 terminates the security check process.

On the other hand, if the settings of the image forming apparatus 1805 are not secure (have a low degree of security), the CPU 201 automatically disconnects the image forming apparatus 1805 from the global network 1802 so as to ensure the security of the image forming apparatus 1805 (S1306). Next, the CPU 201 displays a message saying that the image forming apparatus 1805 has been disconnected from the global network 1802, on the LCD of the operation panel section 111 (S1307). An example of a disconnection notification screen 1501 in this case is shown in FIG. 15.

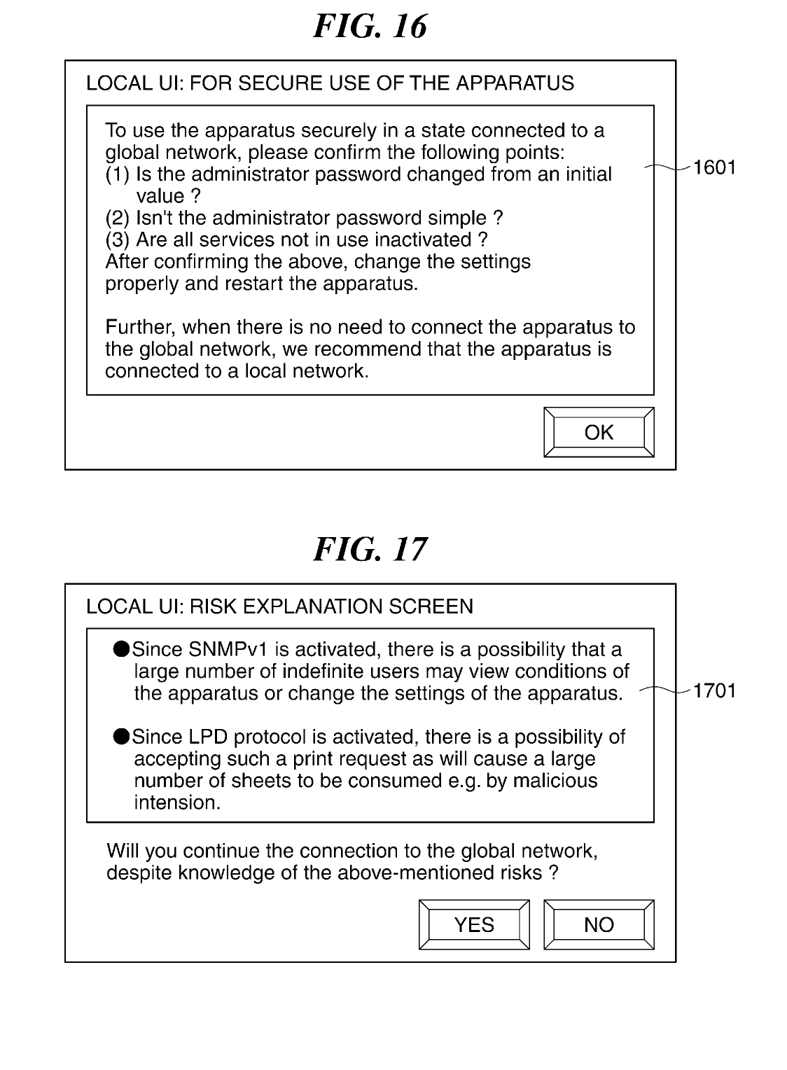

When an OK button on the disconnection notification screen 1501 in FIG. 15 is pressed, the CPU 201 displays an information display screen displaying confirmation items for securely using the image forming apparatus 1805 and a message for prompting the operator to change a connection destination, on the LCD of the operation panel section 111 (S1601). An example of the information display screen is shown in FIG. 16. When an OK button on the information display screen 1601 in FIG. 16 is pressed, the CPU 201 terminates the security check process.

The display of the information display screen 1601 enables the operator of the image forming apparatus 1805 to recognize that there is a possibility of the image forming apparatus 1805 having been directly connected to the global network 1802 and the settings thereof are too dangerous to connect the image forming apparatus 1805 to the global network 1802. Further, the display enables the operator to easily know information e.g. for securely using the image forming apparatus 1805 in a state connected to the global network 1802, at a place where the image forming apparatus 1805 is disposed.

If the settings of the image forming apparatus 1805 are dubious, i.e. require special attention (have a moderate degree of security), the CPU 201 displays a risk explanation screen for explaining risks dependent on the settings of the image forming apparatus 1805 (S1309: see FIG. 17). On the risk explanation screen 1701, the CPU 201 displays a message for confirming whether the image forming apparatus 1805 continues to be connected to the global network 1802 (S1310), despite knowing the risks.

Then, the CPU 201 confirms determination of the operator (S1311), and if the operator has determined that the image forming apparatus 1805 should continue to be connected, the CPU 201 terminates the security check process. This makes it possible for the operator of the image forming apparatus 1805 to continue the connection of the image forming apparatus 1805 to the global network 1802, while knowing the risks expected from the current settings of the image forming apparatus 1805. Therefore, even if the image forming apparatus 1805 is damaged by the connection, the possibility of minimizing the damage is increased.

On the other hand, if the operator has determined that the image forming apparatus 1805 should not continue to be connected, the process proceeds to the step S1306, wherein the CPU 201 disconnects the image forming apparatus 1805 from the global network 1802. Consequently, even after the operator of the image forming apparatus 1805 connects the image forming apparatus 1805 to the global network 1802 without being aware of the risks expected from the connection, it is possible to make the image forming apparatus 1805 secure.

It is possible to notify the user of the above-mentioned warning information (notification information), such as risk information, not visually but aurally, e.g. by using voice.

Further, in the second embodiment, the image forming apparatus 1805 singly determines without cooperating with the client terminal 1806 whether or not there is a possibility of the image forming apparatus 1805 being directly connected to the global network 1802 (actually, whether or not the image forming apparatus 1805 is directly connected to the local network 1804).

This makes it possible to determine the above-mentioned possibility without performing communication between the image forming apparatus 1805 and the client terminal 1806. Further, even when the client terminal 1806 is not equipped with the functions for determining the possibility, the services provided thereto by the image forming apparatus 1805 are not always restricted. This makes it possible to improve communication efficiency and user-friendliness (similarly in the first embodiment).

It is to be understood that the present invention is not limited to the above-described first and second embodiments. For example, the technical ideas according to the first and second embodiments can also be applied to peripheral apparatuses of the information processing apparatus, other than the image forming apparatus (MFP), including a single-function printer, scanner, or copying machine, or an information processing apparatus main unit, such as a personal computer.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-063020, filed Mar. 16, 2009, which is hereby incorporated by reference herein in its entirety.

What is claimed is:

1. An information processing apparatus that has an interface unit connectable to a network and is capable of being operated from an external device via the network, comprising:
a determination unit configured to determine whether or not the network to which the interface unit is connected is a local network; and
a restriction unit configured to restrict operation from the external device when said determination unit determines that the network to which the interface unit is connected is not a local network.

2. The information processing apparatus according to claim 1, wherein said determination unit performs the determination based on an address space to which an IP address set to the information processing apparatus belongs.

3. The information processing apparatus according to claim 1, further comprising a a second determination unit configured to determine a possibility that the network to which the interface unit is connected is a global network when said determination unit determines that the network to which the interface unit is connected is not a local network, and
wherein said restriction unit stepwise restricts the operation from the external device according to the possibility determined by said second determination unit.

4. The information processing apparatus according to claim 3, wherein said second determination unit sends out a predetermined signal via the interface unit, and performs the determination based on whether or not said judgment unit receives a response to the sent signal.

5. The information processing apparatus according to claim 4, wherein when said judgment unit receives a response to the sent signal, said judgment unit recognizes a communication path to the external device having responded to the signal, and performs the judgment based on the recognized communication path.

6. The information processing apparatus according to claim 1, wherein said restriction unit restricts an operation from the external device, which is to be performed for changing setting information of the information processing apparatus.

7. The information processing apparatus according to claim 1, wherein said restriction unit restricts an operation from the external device, which is to be performed for manipulating address information stored in the information processing apparatus.

8. The information processing apparatus according to claim 1, wherein said restriction unit restricts a remote operation from the external device, which is to be performed for manipulating a job executed by the information processing apparatus.

9. The information processing apparatus according to claim 1, wherein said restriction unit automatically cuts off the connection to the network by the interface unit.

10. The information processing apparatus according to claim 1, further comprising a notification unit configured to perform notification to a user of the information processing apparatus according to a result of determination by said determination unit.

11. A method of controlling an information processing apparatus that has an interface unit connectable to a network and is capable of being operated from an external device via the network, comprising:
determining whether or not the network to which the interface unit is connected is a local network; and
restricting operation from the external device when it is determined by said determining that the network to which the interface unit is connected is not a local network.

12. A computer-readable storage medium that stores a program for causing a computer to execute a method of controlling an information processing apparatus that has an interface unit connectable to a network and is capable of being operated from an external device via the network,
wherein the method comprises:
determining whether or not the network to which the interface unit is connected is a local network; and
restricting operation from the external device when it is determined by said determining that the network to which the interface unit is connected is not a local network.
